(19) United States
(12) Patent Application Publication
(10) Pub. No.: US 2026/0018632 A1
(43) Pub. Date: Jan. 15, 2026

(54) APPARATUS FOR GENERATING ELECTRICITY

(71) Applicant: EMISSION FREE GENERATORS, INC., Covina, CA (US)

(72) Inventors: Mark COLLINS, Claymont, DE (US); Chase COLLINS, Claymont, DE (US)

(73) Assignee: EMISSION FREE GENERATORS, INC., Covina, CA (US)

(21) Appl. No.: 19/334,041

(22) Filed: Sep. 19, 2025

Related U.S. Application Data
(63) Continuation of application No. PCT/US2024/031132, filed on May 24, 2024.
(60) Provisional application No. 63/504,623, filed on May 26, 2023.
(60) Provisional application No. 63/504,739, filed on May 27, 2023.

(51) Int. Cl. H01M 8/04082; H01M 8/04746; H01M 8/10; H01M 16/00

(52) U.S. Cl. CPC H01M 8/04208; H01M 8/04753; H01M 16/006; H01M 2008/1095; H01M 2250/402

(57) ABSTRACT

A power generation system includes a housing, a lid defining an opening in the housing, and a chamber inside the housing configured to receive a cartridge comprising a powdered fuel mixture. The system also includes a fluid reservoir that stores a fluid configured to react with the powdered fuel mixture to produce hydrogen gas. A processor is configured to control ingress of the fluid from the fluid reservoir to the powdered fuel mixture in the cartridge and control egress of the gas from the cartridge to the gas storage compartment. The system also includes a generator configured to generate electricity from the gas in the gas storage compartment.

### RELATED APPLICATION

The present application is a continuation of International Application No. PCT/US2024/031132, filed May 24, 2024 entitled, “APPARATUS FOR GENERATING ENERGY”, which claims the benefit of priority to U.S. provisional patent application No. 63/504,623 filed May 26, 2023 and claims the benefit of U.S. provisional patent application No. 63/504,739 filed May 27, 2023, each of which is incorporated herein by reference in its entirety and made part of this specification.

### BACKGROUND

### Field of the Invention

This invention relates to a portable electricity-generating apparatus comprising a reactor for producing hydrogen from a chemical exothermic reaction within a reusable cartridge and a Proton Exchange Membrane (PEM) Fuel Cell to generate electricity, all controlled and monitored to precise limits by proprietary software.

### Related Art

Conventional “off Grid” power generators typically run on gasoline, diesel or fuel variations and are typically used as auxiliary sources of electricity. Traditional power generators that produce noxious gases, high heat signatures, and high audible noise, create significant problems for sensitive and restricted areas and generally cannot be used indoors. These limitations considerably restrict the versatility of conventional power generators.

Solar powered energy sources are a common type of auxiliary power supply. However, these suffer from the disadvantage that they are less effective during inclement weather or low light levels when power is often required.

Increasing awareness of climate change and growing energy demand has led to a significant amount of research and development activities into alternative energy sources, such as hydrogen. Hydrogen can be used as a fuel for fuel cells to produce electric power and heat. Fuel cells convert the chemical energy from hydrogen into electricity through a chemical reaction with oxygen. The by-product of this reaction is water.

Steam can be reacted with methane at high temperatures (e.g. 700-1100° C.) in the presence of a metal-based catalyst (often nickel) to generate hydrogen gas. In this process, toxic carbon monoxide is produced as by-product and, in order to produce steam to react with the methane, large boilers or steam reformers are required.

Another hydrogen generation method involves the electrolysis of water, whereby an electric current is passed through water causing it to decompose into oxygen at the anode and hydrogen at the cathode. Slow reaction time, poor efficiency and cost are restrictive to a convenient and immediately accessible power source.

Reactions between metals and water have also been extensively investigated. For example, aluminum metal reacts with water to generate hydrogen gas according to the following equation:

$$Al ( s ) + 3 {H}_{2} O ( g ) \to {Al ( OH )}_{3} ( s ) + 1.5 {H}_{2} ( g ) Δ H r = - 280 kJ / mol$$

However, a problem with the reaction between aluminum and water is that a protective coating of aluminum oxide is very rapidly formed on the surface of the metal thereby inhibiting further reaction, after a short initial burst of hydrogen generation, further evolution of hydrogen ceases or proceeds only very slowly. The overall slow speed of reaction is a limiting factor for immediate accessible gas.

Various additives that can facilitate the reaction of aluminum with water have therefore been investigated.

Wang et. al. (“Preparation and Hydrolysis of Aluminum Based Composites for Hydrogen Production in Pure Water”, Materials Trans. (2014), 55, pp. 892-898) investigated the effect of additives including Cao, NaCl and low melting point metals (Ga, In and Sn) on the hydrolysis activity of aluminum in water. The total hydrogen yield (volume) per gram of aluminum for compositions containing a mixture of aluminum and Cao composites ranged from 10 to 110 ml. This is far below the maximum theoretical yield of (1358 ml) for 1 g Al reacting with water completely at 25° C. and 1 atmosphere of pressure. By adding NaCl to the Al-Cao compositions, the hydrogen yield increased, but only up to a maximum of 54% of the maximum theoretical yield. However, the authors of this paper found that by using aluminum alloys containing metals such as Ga, In and Sn in combination with Cao and NaCl, yields of greater than 80% could be obtained. However, even with the use of Ga, In and Sn alloys, yields of greater than 80% were only observed at high temperatures (60° C.). The use of such metals and the preparation of the aluminum alloys is expensive, and hence the commercial potential of such mixtures as fuel sources is limited.

Wang et. al. (“Generation of hydrogen from aluminum and water-Effect of metal oxide nanocrystals and water quality”, Int. J. Hydrog. Energy (2011), 36, pp. 15136-15144) also investigated the effect of the addition of various first-row transition metal oxide nanocrystals to the reaction between aluminum and water to generate hydrogen.

Dupiano et al. (“Hydrogen production by reacting water with mechanically milled composite aluminum-metal oxide powders”, Int. J. Hydrog. Energy (2011), 36, pp. 4781-4791) investigated the reaction of several mechanically milled aluminum-metal oxide powders with water. It was found that for the powder containing a mixture of aluminum and CuO, when conducted at room temperature, no reaction was observed for the first 3 days.

Chen et. al. (“Research of hydrogen generation by the reaction of Al-based materials with water”, J. Power Sources (2013), 222, pp. 188-195) investigated the reaction of various compositions containing Al, Cao and NaCl prepared by mechanical ball-milling for hydrogen production.

At the present time, there remains the need for hydrogen-generating compositions that can generate hydrogen gas in high yields at ambient temperatures. If they are to be used as fuels for generating hydrogen for consumption in fuel cells they are required to be in a convenient and accessible user-friendly format, such compositions need to be relatively inexpensive to manufacture and safe to use by untrained operatives. In particular, the compositions should generate hydrogen in a repeatable, controlled manner to avoid overheating and over-pressurization of the hydrogen generating apparatuses in which the compositions may be used and be readily transportable in convenient handheld packages.

Therefore, what is needed is a system and method that overcomes these significant problems found in the conventional systems as described above.

### SUMMARY

In recent years, fuel cells have been utilized to generate electricity in situations where there is no main power available. Fuel cells, which make use of alternative energy sources, have several advantages over traditional fossil-fueled internal combustion engines. PEM Fuel Cells run on hydrogen, produce solely water as a byproduct and no carbon dioxide or carbon monoxide, have a low noise and low heat signature and therefore the versatility and accessibility to use a hydrogen fuel cell generator can be extended to any location and power required situation, given a usable supply of fuel.

One aspect of the present disclosure relates to a static or portable electricity-generating apparatus comprising a reactor for producing hydrogen from a chemical exothermic reaction within a reusable cartridge and a Proton Exchange Membrane (PEM) Fuel Cell to generate electricity, all controlled and monitored to precise limits by proprietary software.

One aspect provides a static or portable apparatus for generating electricity by converting hydrogen generated in situ within the apparatus into electricity. The apparatus comprises a light weight housing inside which are mounted an easily accessible chamber that temporarily houses a cartridge containing consumable hydrogen rich dry powder fuel released via a chemical reaction which exothermically emits gas and a hydrogen fuel cell that consumes the hydrogen gas to produce electricity and electronics that control the complete operation of the invention. The fuel cartridge containing the hydrogen rich dry powder fuel is a separate component to the apparatus.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIGS. 1A and 1B illustrate an example fuel cartridge according to an embodiment;

FIGS. 2A and 2B illustrate an example fuel cartridge according to an embodiment;

FIG. 3 illustrates an example power generation apparatus according to an embodiment;

FIG. 4 illustrates an example power generation apparatus in an open lid configuration with an example cartridge positioned to enter/exit the power generation apparatus according to an embodiment;

FIG. 5 illustrates a side view of an example power generation apparatus in an open lid configuration with an example cartridge positioned to enter/exit the power generation apparatus according to an embodiment;

FIG. 6 illustrates a cross section view of an example cartridge positioned in an example power generation apparatus according to an embodiment;

FIG. 7 illustrates an example system for generating electricity according to an embodiment; and

FIG. 8 illustrates an example process for generating electricity according to an embodiment.

### DETAILED DESCRIPTION

Disclosed herein are systems, methods, and non-transitory computer-readable media for generating electricity. In one aspect, a power generation system comprises a reactor that produces hydrogen from a chemical exothermic reaction within a reusable cartridge. The power generation system also includes a Proton Exchange Membrane (PEM) Fuel Cell to generate electricity from the hydrogen produced within the chamber.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

In one aspect, a power generation system is disclosed herein. The power generating system provides continuous power output ranging between, but limited to, 5 Watts (W) to 15,000 W. The power generation system is able to interface with other power providing items, such as an electric or ICE (internal combustion engine) vehicle, to improve performance levels, or operate as a standalone unit providing backup or primary power to items without an internal power source (collectively referred to as PRI-Power Requiring Item). In one aspect, the power generating system provides PRI with the energy required to charge and recharge batteries and devices and delivers energy to operate the PRI and other devices that require electricity to operate, e.g., televisions, refrigerators, medical devices, and the like. In one aspect, output from the power generation system may be generated by smaller sub-systems, with each sub-system providing variations of energy to meet the demands of power required by the PRI.

Output Power. In one aspect, the power generation system may produce no less than 5 W of electric power at various output connectors continuously. A total output of 15,000 W may also be achieved but this is not an upper limit to the output. Output power may be provided by sub-systems in increments of 20 W or 50 W or 1,000 W or 3,000 W, or some other amount, but is not limited to incremental numbers. In one aspect, the power generation system may provide Direct Current (DC) and/or Alternating Current (AC) depending upon the PRI requirement. In one aspect, the voltage and amps provided by the power generation system are variable to meet the demands of the PRI. The sub-systems of the power generation system may share AC & DC power amongst each receptacle.

In one aspect, the power generation system utilizes a hydrogen creating powder contained within a cartridge that is a temperature resistant plastic formed grid on four sides covered with a high temperature permeable fabric on the top side and a metal on the base side, to act as a heat sync. Alternatively, the base can be formed from plastic or other material. When the cartridge is placed within an appropriate hydrogen generator apparatus that provides a measured distribution of water to specific grids of the cartridge, hydrogen gas is produced that can be used within the power generation system.

In one aspect, a hydrogen-generating composition generates hydrogen when contacted with water. In exemplary embodiments, the hydrogen-generating composition includes aluminum powder, an alkaline metal oxide powder, and either a post-transitional metal oxide powder or a chloride salt powder of an alkali metal or alkaline earth metal a hydrogen-generating composition is prepared by mixing An efficient method of combining/mixing is achieved within the appropriate dry powder mixing unit, careful consideration is given to the temperature and humidity conditions while combining/mixing is taking place. A constant temperature of 69 F is preferred with a humidity <10%. The combined/mixed powder is packaged in specific measured quantity to the cartridge sectioned off into a grid where all four sides of the square/rectangle are sealed to a thin metal base, securely holding the powder within, after “filling” the top of the grid has a permeable fabric sealed to hold the powdered fuel in place. The top fabric can be made from a variety of materials, including but not limited to; high temperature resistant paper, Nylon, fiberglass thread, aluminum, glass, silica cloth, silicone/fiberglass cloth, copper mesh, brass mesh or Stainless-Steel Mesh. The material advantageously allows water to pass easily though the material to the powder for reaction and allows the hydrogen generated by the reaction to exit, but securely prevents powder from escaping. In one aspect, a preferred mesh size of +450 microns advantageously contains the smallest combined/mixed powder particle size of >500 microns. The package cartridge material also preferably resists high temperatures and is inert in reactivity. The high temperatures include, but are not limited to, 10c-50c and 20c-60c and 50c to 100c and 30c to 120c.

The powder micron size used within the hydrogen producing fuel facilitates an efficient reaction taking place. The raw materials are sieved to ensure a span D10, D50, D90 curve of material is the correct size.

The amount of catalyst powders used within the mixture can be altered to increase or decrease the rate of reaction. If a higher rate of reaction is desired, a larger amount can be used. If the hydrogen power system is continuously used in cold climates, a larger amount of catalyst may be used to increase the reaction temperature, and surrounding components.

The powdered fuel can also be formed into a solid of any shape and size and kept within a blister pack. The solid fuel can be placed into an appropriately sized hydrogen generator apparatus (also referred to herein as a reactor) within the operating unit where the activating fluid can be administered in any of the forms above.

In one aspect, the power generation systems and methods provide a composition which generates hydrogen in high yields when contacted with water. The release of hydrogen is controlled by the reactor to provide low pressures of hydrogen over a prolonged period.

In one aspect, the power generation systems and methods provide compositions that are useful in generating hydrogen for conversion into electricity by hydrogen fuel cells.

In one aspect, the power generation systems and methods provide that the compositions be contained in a ready to use, safe, convenient, practical and price conscious format.

The inventors have investigated the effects of the addition of single metal oxides and single metal chlorides to the reaction between aluminum and water, and the effects of using combinations of metal oxides or combinations of metal chlorides as additives have been determined. The inventors have found that by using a combination of alkaline metals and transition metal oxides, the total volume of hydrogen produced by the fuel within the power generation system is greater than when either one of the oxides is used alone.

Accordingly, in one aspect, a composition is provided that generates hydrogen when contacted with water, the composition comprising particles of: (a) aluminum, (b) an alkaline metal oxide; (c) a transition metal oxide; and (d) one or more chloride salts of alkali metals or alkaline earth metals.

The compositions typically comprise a plurality of chloride salts. The composition may comprise a salt comprising or consisting of sodium ions, potassium ions, calcium ions and chloride ions. In one embodiment, the composition comprises a mixture of NaCl, KCl and CaCb.

In a further embodiment, the composition consists of or consists essentially of a mixture of NaCl, KCl and CaCb.

It has also been found that by using a combination of multiple metal chloride salts, the total volume of hydrogen generated is greater than when any one of the chloride salts is used alone.

Accordingly, in another aspect, a particulate composition is provided that generates hydrogen when contacted with water, the composition comprising particles of: (a) aluminum; (b) one or more metal oxides; and (c) a mixture of NaCl, KCl and CaCb.

The speed of reaction is a critical aspect to ensure the accessibility of the hydrogen carrier in a multitude of situations and locations. In one aspect, a simple packaging method and low cost production of the composition is provided. The packaging method advantageously facilitates portability and accessibility to an operator of the power generation system, combining safety, cost and convenient use. Advantageously, the cartridge that houses the powdered (or solid) fuel can be recycled and/or re-used.

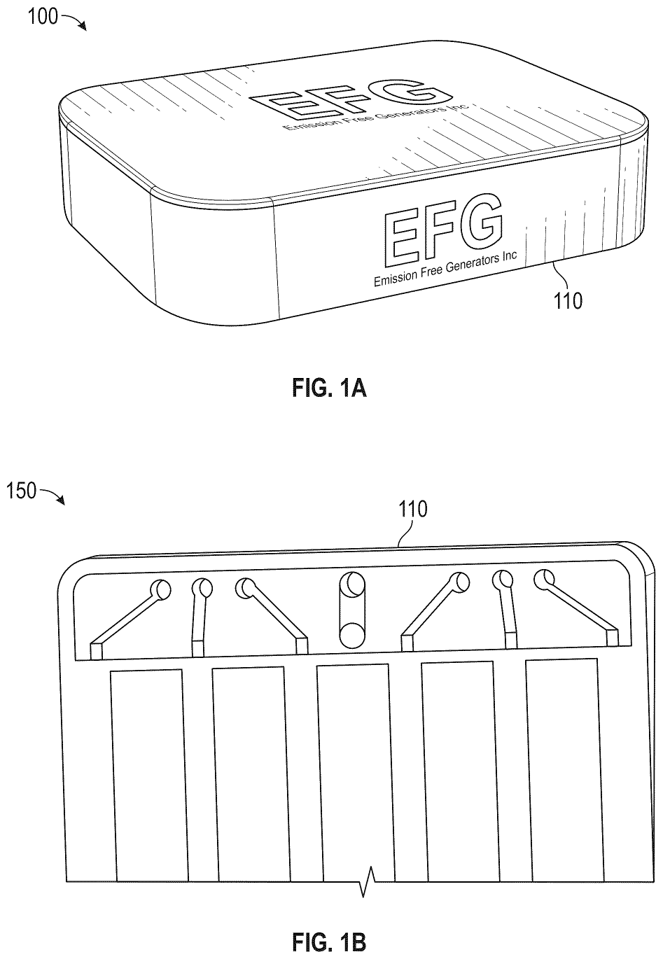

In one aspect, the powdered fuel is contained within a cartridge comprising packaging material that allows for physical handling of the cartridge, and by extension the powdered fuel, without the operator coming into direct contact with the powdered fuel. FIG. 1A shows a typical cartridge 100 enclosed by its housing 110 and FIG. 1B shows a view of a portion of a typical cartridge 150 and its housing 110. FIG. 1B also shows several through holes and channels that may be used to ingress a fluid for reaction with the powdered fuel or egress a gas produced by the reaction between the fuel and the fluid. In the illustrated embodiments, the cartridges 100 and 150 contain a powdered fuel that has a depth in the range of 3-15 mm, or 5-13 mm, or 7-11 mm of combined/mixed powders. In one aspect, the width and length of the cartridge are dependent upon the reactor size and/or the gas reaction chamber size, which in turn may be dependent upon the desired use for the power generation system. In one aspect, the depth of the powdered fuel in the cartridge is critical to the completion of the reaction process.

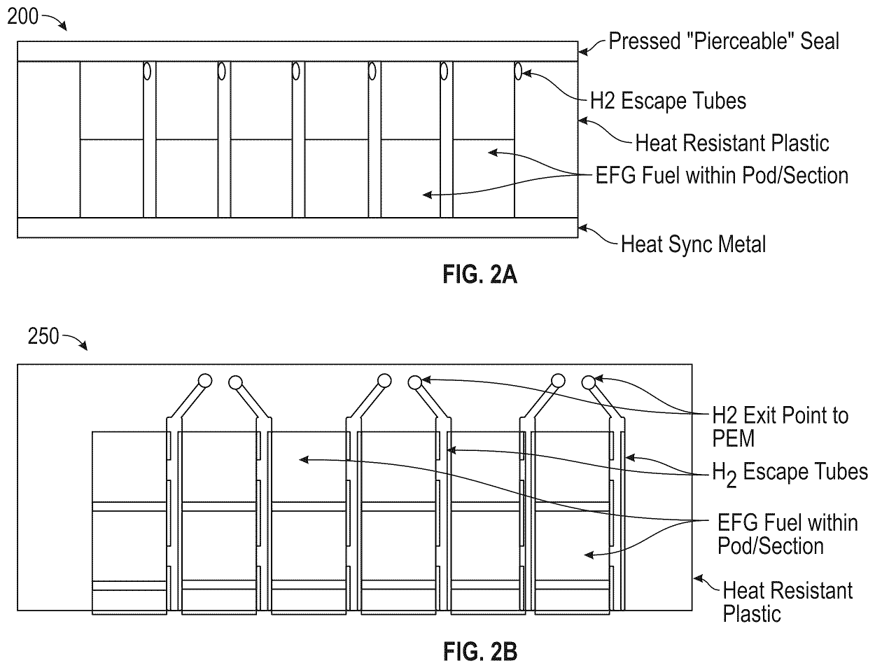

FIG. 2A shows a cross sectional view of a cartridge 200. The base of the cartridge may be formed from a heat sink material (e.g., a metal) or from some other material (e.g., a heat resistant plastic). The cartridge contains a fuel mixture having a depth in the range of 3-15 mm, or 5-13 mm, or 7-11 mm of combined/mixed powders in each of a plurality of pods/sections (also referred to herein as smaller grid sections). An advantage of separating the fuel into the smaller grid sections is that hydrogen can be generated in smaller quantities to control the amount of electricity that is generated and align the amount of electricity that is generated to the amount required for a particular use. The cartridge 200 also includes a plurality of channels/tubes through which the hydrogen gas generated by a reaction between the fuel and a fluid can escape the cartridge 200 and be routed to the PEM. In one aspect, the housing of the cartridge 200 is a heat resistant plastic and an upper portion of the cartridge 200 includes a water/gas permeable membrane that seals the powdered fuel mixture inside the cartridge while allowing a fluid (e.g., water) to enter into the cartridge and also allowing a gas (e.g., hydrogen) to exit from the cartridge. In one aspect, the channels/tubes are excluded because the gas exits the cartridge via the permeable membrane.

FIG. 2B shows a top view of a cartridge 250 and illustrates example channels/tubes for the gas to escape and the powdered fuel at the bottom of each smaller grid section. Additionally shown is the heat resistant plastic housing of the cartridge 250.

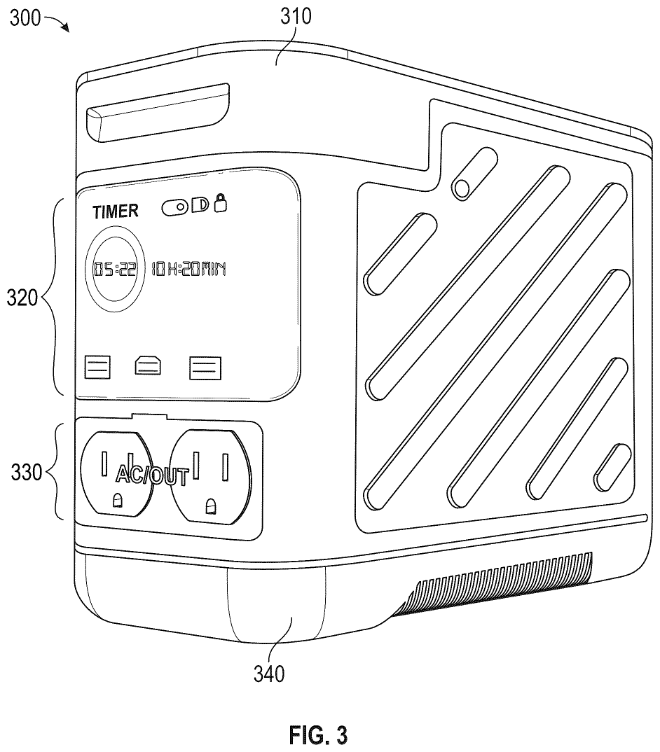

In one aspect, prior to being used, the cartridge is stored in a vacuum sealed aluminum foil sleeve (or other suitable material that ensures a sunlight, water, air and moisture seal). The sleeve advantageously allows for long term storage of the fuel, in excess of 5 years, or 10 years, or even 50 years. The operator opens the scaled packaging and removes the cartridge and places the cartridge in a tray receptacle positioned within the opening/closing lid structure of the power generation system. The power generation system shown in FIG. 3 includes a housing 340 and a lid 310 that provides an opening in the housing 340. The power generation system also includes a user interface 320 and a plurality of power out connections 330.

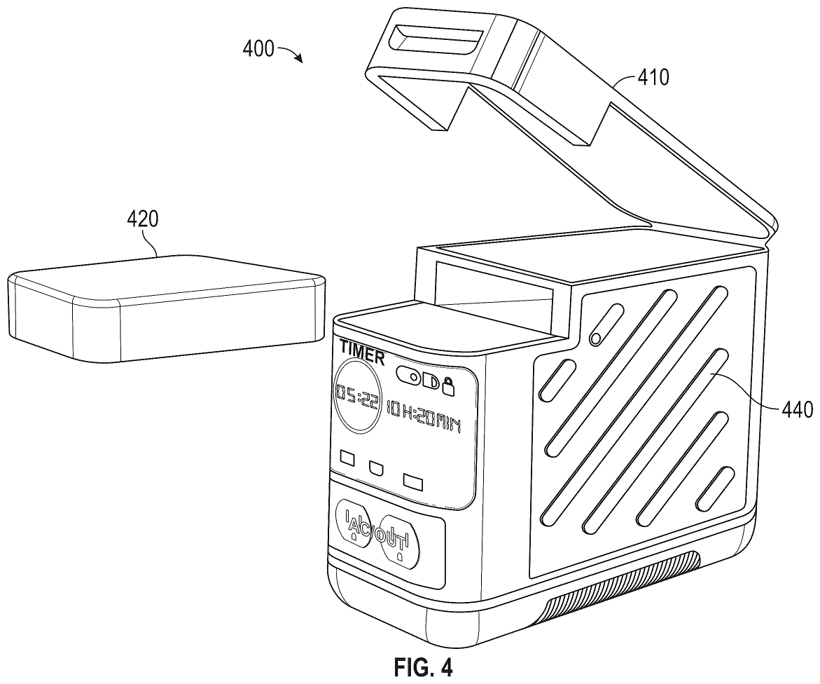

The power generation system shown in FIG. 4 includes a housing 440 and a lid 410 in an open position. The lid 410 provides an opening in the housing 440. In the illustrated embodiment, the lid 410 is open and a cartridge 420 is positioned to be inserted into the receptacle tray under the lid. When the reaction of the fuel is complete, and the hydrogen has been released from the fuel, the spent cartridge 420 can be removed from the receptacle tray and returned to the foil packaging for disposal or preferably for return to the manufacturer for recycling the cartridge and repurposing the spent fuel.

In one aspect, the spent powdered fuel is non-toxic and can be disposed by normal garbage disposal methods, however, it is also possible for the spent powdered fuel to be returned to a specified location where the spent powdered fuel is removed from the cartridge and rejuvenated/re-conditioned to be used again within a newly milled or prepared powdered fuel mixture. In this fashion, spent fuel can advantageously be repurposed.

In one aspect, the powdered fuel is distributed into a number of smaller grid sections inside the larger cartridge system that is sealed at point of manufacture. The smaller grid sections are fixed into the sealed cartridge unit at various heights and degrees of inclination. When water is inserted into the cartridge the water makes contact only with certain parts of the cartridge and only certain of the smaller grid sections at any one time. As the reaction to produce hydrogen diminishes, additional smaller grid sections, and their corresponding powdered fuel, come into contact with water input into the cartridge and a new reaction is created.

In one aspect, pure anti-freeze (Ethylene glycol) can be mixed with the water used for the reaction within power generation system. Mixing pure anti-freeze with the water in this fashion advantageously facilitates below freezing operation of the power generation system in a variety of geographical locations.

In one aspect, the fluid used within the reaction can be, but is not limited to, de-ionized water, distilled water, filtered water, pond water, sea water, rain water, human or animal fluids. These fluids may be used in conjunction with relevant filters in the power generation system.

In one aspect, during the reactive stage of the power generation process, heat is produced and water vapor is created, some of which is transferred out of the smaller grid sections within the cartridge as moisture rich hydrogen and some of which is kept within the cartridge to be absorbed by the powdered fuel. As the vapor condenses within the cartridge (e.g., within a smaller grid section) the condensed water droplets combine with the powdered fuel to aid the hydrogen production by sustaining the reaction without the need for additional water input from an external source, thereby conserving water consumption.

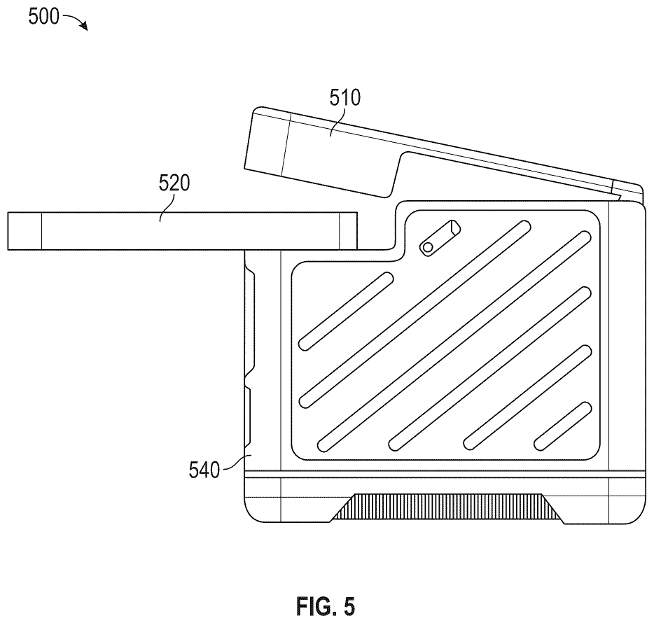

FIG. 5 illustrates a side view of a power generation system 500 having a housing 540. In the illustrated embodiment, a cartridge 520 is positioned to be inserted into the tray under the open lid 510 of the power generation system 500. In one aspect, the lid 510 can be actuated by a lever or a button or some other type of mechanical latch and release mechanism.

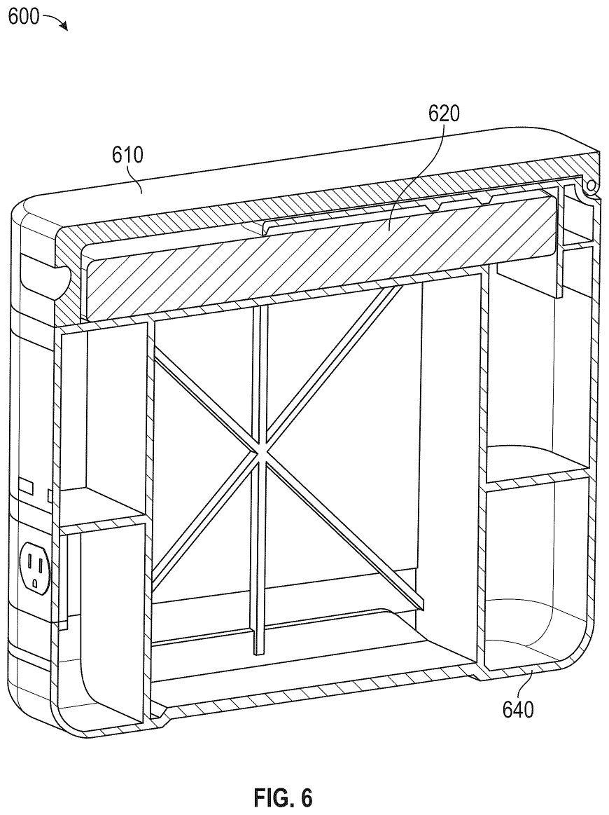

FIG. 6 illustrates a cross sectional view of a power generation system 600 having a housing 640. In the illustrated embodiment, a cartridge 620 is positioned in the tray under the closed lid 610 of the power generation system 600. In one aspect, when the cartridge is positioned in the tray and the lid 610 is closed, water from a fluid delivery system (e.g., a water injection system) can be delivered to the inside of the cartridge 620 so that the water may react with the powdered fuel inside the cartridge 620.

In one aspect, the entire reaction between the fluid (e.g., water) and the powdered fuel happens inside the cartridge and the cartridge is configured to contain the pressure from the hydrogen gas generated by the reaction.

In one aspect, there are at least two individual inlets or through-holes on the cartridge. For example a first through-hole may allow water to be introduced into the cartridge. Additionally, a second through-hole may allow for hydrogen generated by the reaction between the water and the powdered fuel to be evacuated out of the cartridge. In one aspect, the two through holes may be configured with sealing glands or some other type of valve to regulate the ingress/egress of the water and/or hydrogen. Advantageously, the powdered fuel is positioned within the cartridge before the reaction and the spent powdered fuel remains within the cartridge after the reaction.

In one aspect, a portion of the lid and a portion of the base plate where the cartridge sits within the tray may be lined with a material (e.g., a metal) to facilitate heat transfer away from the cartridge.

In one aspect, the lid may be secured to the power generation system by way of a hinge at a first position and a latch at a second position. Advantageously, a lever or other mechanical release for the latch may be positioned near the latch. Additionally, the tray may be configured to extend outward from its recess in the power generation system when the lid is opened and to retreat back into the power generation system (e.g., with a newly inserted cartridge) then the lid is closed.

In one aspect, when the lid is closed, a portion of the lid forms a pressure seal with a corresponding portion of the body of the power generation system when the lid is closed. Advantageously, the pressure seal is configured to contain hydrogen.

In an alternative embodiment, the cartridge is configured to be attached to a surface (e.g., an upper surface) of the power generation system. In this embodiment, the two through-holes are positioned in a surface (e.g., a lower surface) of the cartridge such that protrusions from the power generation system align with and engage the through-holes in order to ingress water into the cartridge during operation and to egress hydrogen from the cartridge during operation. In such an embodiment, the power generation system may also include one or more latches that are designed to secure the cartridge to a surface of the power generation system.

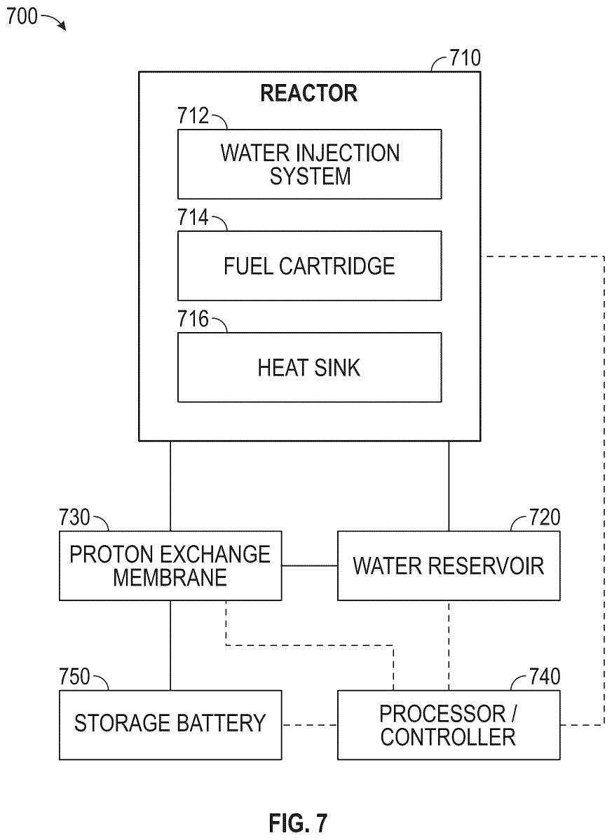

FIG. 7 illustrates example components of a power generation system 700 according to an embodiment. The system 700 includes a reactor 710 configured to facilitate chemical reactions between water and the powdered fuel, where the reaction produces at least hydrogen. The reactor 710 includes a receptacle tray configured to receive a fuel cartridge 714. In one aspect, the receptacle tray is configured to function as a heat sink 716 to allow heat generated by the chemical reaction to be drawn out from the cartridge 714. The reactor 710 also includes a water injection system 712 (also referred to as a fluid delivery system) configured to draw water from a water reservoir 720 and inject the water into the fuel cartridge 714. In one aspect, the fuel cartridge 714 comprises a plurality of smaller grid sections that each contain a portion of the powdered fuel and the water injection system 712 is configured to deliver water to each smaller grid section independently.

In one aspect, a pressure sensor is employed to help regulate the reaction rate for on demand power generation. In one aspect, once hydrogen has been produced by the reactor, the hydrogen is passed through two water traps to decrease water held within the gas. This water is recycled into the reaction vessel (e.g., the cartridge generally or one or more smaller grid section of the cartridge) to aid further hydrogen production. In one aspect, the hydrogen gas, which has been passed through one or more water traps and preferably now a dry gas, is passed through to a proton exchange membrane 730 where DC electricity is produced. In one aspect, the proton exchange membrane 730 is a PEM Fuel Cell. Electricity generated by the proton exchange membrane 730 may be output to a storage battery 750. The storage battery 750 may subsequently provide inverted 110/240 VAC to one or more electrical devices as required. In one aspect, a custom power management system (not shown) may be used to convert high voltage DC power generated by proton exchange membrane 730 to a smooth DC power that can be output to the storage battery 750 or output directly to one or more electrical devices.

In one aspect, the power generation system 700 includes one or more processors and/or controllers 740 that execute software to control the operation of the power generation system 700. For example, the processor 740 controls and coordinates operation of the reactor 710, the water reservoir 720, the proton exchange membrane 730 and the storage battery 750. In one aspect, certain software executed by the one or more processors 740 may include firmware that is configured to control and thereby safely operate the subsystems within the power generation system 700.

In one aspect, firmware may control one or more water injection pumps to appropriately dose the fuel in the cartridge and thereby control the reaction between the water and the powdered fuel. Such control may be implemented by controlling an amount of pressure applied to chamber containing water and thereby controlling the amount of water introduced into the cartridge via one or more through-holes.

In one aspect, one or more sensors may be monitored by the firmware and the output of the one or more sensors analyzed by the firmware to determine when and where (e.g., to which smaller grid section) water needs to be injected. Similarly, the one or more sensors may be monitored by the firmware and the output of the one or more sensors analyzed by the firmware to maintain a desired pressure in the cartridge. For example, the feedback from one or more sensors may be analyzed to determine a current pressure in one or more of the smaller grid sections and if the pressure is not within a predetermined range, the firmware may exercise control to inject additional water into the smaller grid section to increase the reaction and raise the pressure to be within the desired range.

In one aspect, the firmware may monitor the one or more sensors to maintain a desired temperature within the cartridge. For example, the feedback from one or more sensors may be analyzed by the firmware to determine a current temperature in one or more of the smaller grid sections (or the entire cartridge) and if the temperature is not within a predetermined range, the firmware may control a cooling system to engage in order to drive the temperature to be within the predetermined range. In one aspect, the predetermined range is 40 C-70 C.

In one aspect, the firmware operates a PEM control system to ensure proper operation of the PEM system. For example, the firmware may control one or more fans configured to ingress oxygen through the PEM to facilitate the reaction. In one aspect, the firmware may analyze the output of the one or more sensors to determine the need for the ingress of oxygen through the PEM to facilitate the reaction.

In one aspect, the firmware may also may also control the power being supplied to the PEM control system in order to engage and disengage the PEM. In one aspect, the PEM control system may also control a fluid egress system to purge fluid (e.g., water) from the cartridge (or a smaller grid section) at certain intervals based on the demand of the electrical load or the amount of power to be supplied.

In one aspect, the firmware also controls a fluid management system to manage the release of water in the feed lines as necessary.

In one aspect, the firmware also controls a power management system to manage power delivered to the various components of the power generation system 700.

In one aspect, the firmware also controls battery monitoring, overall temperatures, electrical voltages provided, electrical currents provided, user interface input and output devices, graphical user interfaces, display of information and warnings and errors, communications, setup/troubleshooting, and operator instructions. The firmware may also control various light emitting diodes (LEDs) as visual indicators/warnings and audio indicators/warnings,

In one aspect, the firmware provides a command line interface for testing and communication between subsystems and manages error handling to ensure operational safety. The firmware may also provide a data manager for system monitoring, development, and debugging of instructions and/or automated procedures.

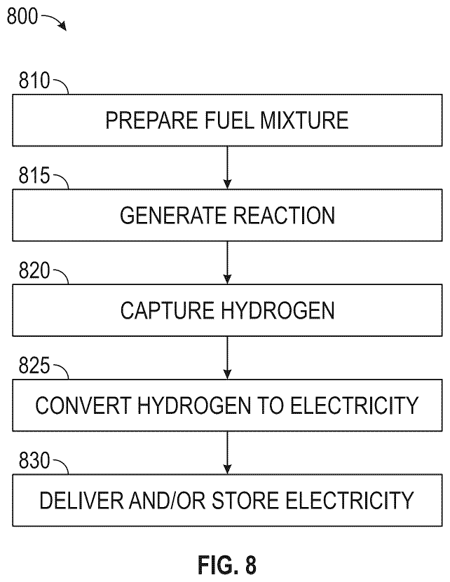

FIG. 8 illustrates an example process 800 for generating electricity according to an embodiment. In one aspect, the process may be carried out by the system previously described with respect to FIG. 7. Initially, at 810 the fuel mixture is prepared. Preparation of the fuel mixture may begin with grinding the fuel components into a powder and mixing the powder and depositing the powder into a fuel cartridge. Preparing the fuel mixture also includes inserting the cartridge into the receptacle tray of the power generation system and closing/sealing the lid of the power generation system to ensure that the cartridge is appropriately positioned relative to the water injection system so that water may be delivered to one or more smaller grid sections of the cartridge to react with the powdered fuel contained within the smaller grid section.

Next, at 815 the reaction between the fluid (e.g., water) and the powdered fuel is generated. The reaction may be generated by a processor of the power generation system controlling the water injection system to deliver an amount of water to a smaller grid section at a predetermined rate in order to cause the water to react with the powdered fuel and consume all of the powdered fuel.

Next, at 820, the system captures the hydrogen gas that is generated by the reaction between the water and the powdered fuel. In one aspect, the hydrogen gas is initially contained within the smaller grid section of the cartridge and then the gas escapes the smaller grid section via a channel/through hole or via a permeable membrane that allows water to enter the smaller grid section and gas to exit the smaller grid section while preventing the powdered fuel mixture from escaping the smaller grid section. Advantageously, the hydrogen that exits the fuel cartridge is routed to a generator (e.g., a proton exchange membrane) within the power generation system.

Next, at 825, the hydrogen gas is converted to electricity. In one aspect, the hydrogen gas is converted to electricity using a proton exchange membrane.

Next, at 830, the electricity that has been generated is delivered to a load (e.g., an electrical device connected to the power generation system) or stored in a storage battery. In one aspect, a power module may be employed to convert the DC electricity generated by the generator before delivery and/or storage.

### Example 1

In one aspect, the power generation system has a housing fabricated from compatible metals and materials that are inherently corrosion resistant or are treated to prevent the various forms of corrosion and deterioration that may be encountered in storage and operating environments. The lid of the power generation system is configured to open to allow the fuel cartridge to be inserted into the power generation system where the cartridge is connected to one or more access points that allow fluids from the power generation system to flow into the cartridge to facilitate a reaction with the powdered fuel and to allow and hydrogen gas generated by the reaction to flow out from the cartridge into the power generation system.

In one aspect, the shape of the lid of the power generation system can be oblong sufficient to only fit the fuel cartridge. The lid is configured to open and allow insertion of the cartridge into the power generation system. As the reaction takes place between the water and the fuel inside the cartridge, the gas that is generated by the reaction immediately escapes to one or more smaller grid chambers within the cartridge and eventually flows out from the cartridge to a gas storage compartment in the power generation system.

When the lid of the power generation system is closed, the lid is configured to withstand pressure up to up to 500 psi. The lid and the tray within which the cartridge is inserted is configured for thermal dissipation via the metal base of the cartridge during the chemical exothermic reaction. Advantageously, the metal base of the cartridge collects heat from the reaction within the cartridge and that heat is dissipated to the power generation system via the tray. Additionally, high efficiency fans and lower temperature operation of the reactive chemistry combine to decrease the operational temperature of the power generation system. In one aspect, the power generation system is configured to operate in ambient temperatures ranging from −40° F. to 135° F.

In one aspect, the firmware (e.g., software) that executes on one or more processors of the power generation system control water dosing of the powdered fuel in order to control the chemical reactions that generate the hydrogen.

Accordingly, the fluid dosing software system meters out the specified amount of fluid required to be present in the cartridge (or in each smaller grid compartment within the cartridge) based on the power generation requirement, which dictates the quantity of hydrogen that needs to be generated.

For example; during a typical reaction between water and the powdered fuel, hydrogen is created. In such a typical reaction, 5 L of gas per minute sustained for one hour is required for the fuel cell to generate and provide a usable 300 WHr. To generation 5 L of has per minute, the power generation system is configured to react 3.76 g of powered fuel with 3.75 ml fluid every minute. Accordingly, the fluid dosing software system is configured to input 3.75 ml of fluid into the cartridge (e.g., into one of the smaller grid compartments within the cartridge) at a rapid rate and in one dose to generate the required 5 L of gas per minute. As the total amount of fluid involved in the total reaction approaches, the powdered fuel approaches exhaustion. When the powdered fuel is exhausted, the reaction ends and therefore hydrogen gas is no longer produced. At that time, the fluid dosing software is configured to input fluid into a next one of the smaller grid compartments within the cartridge to repeat the process and continue generating hydrogen gas. If more hydrogen gas is required than can be generated by a single smaller grid compartment, the fluid dosing software is configured to simultaneously add fluid to more than one smaller grid compartment within the cartridge, thereby increasing the fluid input, the hydrogen generation, and therefore the electricity generated and the power output from the power generation system.

In one aspect, the firmware is configured to track the smaller grid compartments that have been used so that the power generation system can determine when the powdered fuel in the total cartridge has been exhausted.

In one aspect, during operation, PEM fuel cells create a small amount of pure water as a byproduct of the internal reaction. The power generation system is configured to send this pure water out to atmosphere. In one aspect, the power generation system is configured to route the purge output (including the created pure water) back into one or more smaller grid compartments in order to generate more hydrogen from the reaction between the powdered fuel and the pure water.

In one aspect, to further increase efficiency of the power generation system, the gas that is used to purge the water can also be returned back into the original hydrogen feed system at a low pressure. This will reduce the amount of gas required for operation of the power generation system by approximately 2%.

In one aspect, the fuel cartridge can take many forms. For example, the fuel cartridge may be made from a plastic material and include a ‘break away’ seal. Before use, the cartridge is advantageously completely sealed with the powdered fuel on the inside. When the cartridge is placed into the power generation system tray, one or more small through holes are created in the plastic material to penetrate at least one smaller grid compartment. The one or more small through holes advantageously allow the input of a fluid into the cartridge and the output of a gas from the cartridge to the power generation system. In one aspect, the cartridge comprises a plurality of smaller grid compartments that are sealed from each other such that water input to one of the smaller grid compartments to generate a reaction with the powdered fuel does not also generate a reaction with the powdered fuel in a separate smaller grid compartment. In other configurations, the cartridge may only have a single reaction chamber. The configuration of the cartridge, with a single reaction chamber or a plurality of reaction chambers (e.g., smaller grid compartments) can advantageously be selected based upon the intended use and/or the anticipated power generation needs.

In one aspect the cartridge may be formed from a plastic material with a protective seal that covers all of the smaller grid compartments in the cartridge. In one aspect, the seal is configured to permit reusable piercings while keeping the contents secured in the cartridge. For example, after the fluid has been input into the smaller grid compartment, the object that pierced the smaller grid compartment is removed and the sealing material closes the through hole.

In one aspect, the cartridge may be formed from heat and chemical resistant materials that are suitable for reuse and for recycling.

In one aspect, the cartridge comprises a plurality of smaller grid compartments that each function as a separate reaction chamber and each smaller grid compartment contains the powdered fuel. In one aspect, there are about 10 smaller grid compartments and each compartment contains approximately 10% of the overall powdered fuel in the cartridge. Advantageously, having multiple smaller grid compartments aids in keeping the powdered fuel in a desired position and at a desired depth, for example, 7-11 mm depth. Additionally, the cartridge may also include one or more chambers that contain the activator (e.g., a fluid). The activator may be stored in a variety of mediums including water, thixotropic water, gel etc. The activator and powder are advantageously kept separated from each other in the cartridge, for example by a removable film, aluminum, plastic etc. When the separator is removed, e.g., by human action or automatic means, the reaction between the activator and the powdered fuel can take place.

In one aspect, the cartridge is configured to be usable in any orientation, e.g., powder over activator, activator over power, vertical, or horizontal. Additionally, for the reaction to take place, the powder can be added to the activator or the activator can be added to the powder.

In one aspect, the power generation system is configured to operate on a level surface. However, the power generation system may also operate on inclined surfaces. In one aspect, to initiate operation, the fluid chamber is filed with the activator fluid, unless the fuel cartridge includes activating fluid. The lid of the power generation system is opened and the cartridge is positioned in the tray/receptacle. The lid is then closed and sealed and the power generation system is turned on. In one aspect, the power generation system uses an internal battery system for its operation.

In one aspect, to initiate the generation of electrical power, the power generation system is configured to input a specified amount of fluid into a first smaller grid compartment within the cartridge to start a chemical reaction. Hydrogen gas (H2) is generated within the smaller grid compartment by the chemical reaction the hydrogen gas leaves the smaller grid compartment through an exit channel, for example, a pipe that is configured to withstand the pressure and heat of the hydrogen gas. The moisture rich hydrogen gas is routed to one or more first water traps to remove condensing water from the hydrogen gas. The hydrogen gas then enters a pressure reducer that adjusts the hydrogen gas pressure to a desired 6-9 psi before entering one or more second water traps to further remove moisture from the hydrogen gas. The gas then travels through a controllable valve to enter the PEMFC (Proton Exchange Membrane Fuel Cell) to be converted into useable DC electricity. The power generation system is configured to (1) step up the DC power to AC and boost the output to 110/240 VAC and/or (2) transfer the DC power directly to a storage battery that provides power for operation of the power generation system and/or provides power to an electrical outlet that in turn provides power to a device connected to the power generation system. In one aspect, a user interface presents power output and other basic operational data. When the fuel cartridge has been depleted the power generation system will continue to provide power to connected devices via the storage battery. The spent fuel cartridge may be replaced with a new fuel cartridge and the above operation repeated to continuously generate and provide power to the storage battery for subsequent use. If the power generation system is not operational for period of time, the power generation system is configured to power down to protect the PEM.

In one aspect, a particular advantage of the power generation system is that hydrogen is only produced by the system at the same rate as the output load, this ensures that hydrogen storage is not required and a high level of fuel efficiency is maintained. Additionally, if a small amount of excess hydrogen is generated, the system is configured to convert the hydrogen to electricity and store the electricity in the onboard storage battery.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A power generation system comprising:
a housing;
a lid defining an opening in the housing, the lid configured to open and provide access to a chamber inside the housing, the chamber configured to receive a cartridge comprising a powdered fuel mixture, wherein the cartridge comprises a plurality of smaller grid sections each comprising a portion of the powdered fuel mixture;
a fluid reservoir configured to store a fluid configured to react with the powdered fuel mixture;
a fluid delivery system configured to deliver fluid from the fluid reservoir to the powdered fuel mixture in the cartridge;
a gas storage compartment configured to receive a gas generated by a reaction between the fluid the and the powdered fuel mixture;
a generator configured to generate electricity from the gas in the gas storage compartment; and
a control system configured to control ingress of fluid from the fluid reservoir to the powdered fuel mixture in the cartridge and control conversion of the gas to electricity by the generator.

2. The power generation system of claim 1, wherein the generator is a proton exchange membrane.

3. The power generation system of claim 2, wherein the generator is configured to generate a water byproduct and deliver the water byproduct to the fluid reservoir.

4. The power generation system of claim 1, wherein the control system is configured to control the generator to provide electricity generated by the generator to a battery for storage.

5. The power generation system of claim 1, wherein the chamber comprises a heat sink configured to draw heat from the cartridge.

6. The power generation system of claim 1, where the fluid delivery system is configured to deliver fluid from the fluid reservoir to the powdered fuel mixture in each of the smaller grid sections independently.

7. The power generation system of claim 6, wherein the control system is configured to control ingress of fluid from the fluid reservoir to the powdered fuel mixture in each of the smaller grid sections independently at a predetermined rate.

8. A method for generating electricity comprising:
receiving a cartridge comprising a powdered fuel mixture, wherein the cartridge comprises a plurality of smaller grid sections each comprising a portion of the powdered fuel mixture, further comprising delivering fluid from the fluid reservoir to the powdered fuel mixture serially to each smaller grid section;
aligning the cartridge relative to a fluid delivery system configured to deliver fluid from a fluid reservoir to the powdered fuel mixture in the cartridge;
injecting a fluid into the cartridge to generate a reaction between the fluid and the powdered fuel mixture;
routing a gas generated by the reaction between the fluid and the powdered fuel mixture to a gas storage compartment; and
generating electricity from the gas in the gas storage compartment.

9. The method of claim 8, wherein the generator is a proton exchange membrane.

10. The method of claim 9, wherein generating electricity comprises generating a water byproduct.

11. The method of claim 10, further comprising delivering the water byproduct to the fluid reservoir.

12. The method of claim 8, further comprising providing electricity generated by the generator to a storage battery for storage.

13. The method of claim 8, further comprising providing electricity generated by the generator to an electrical device.

14. The method of claim 8, further comprising delivering fluid from the fluid reservoir to at a predetermined rate configured to exhaust all of the powdered fuel mixture in each smaller grid section.

15. The method of claim 8, wherein the cartridge comprises a plurality of smaller grid sections each comprising a portion of the powdered fuel mixture, further comprising delivering fluid from the fluid reservoir to the powdered fuel mixture simultaneously to a plurality of each smaller grid sections.

16. The method of claim 15, further comprising delivering fluid from the fluid reservoir to at a predetermined rate configured to exhaust all of the powdered fuel mixture in each smaller grid section.
